(19) United States
(12) Patent Application Publication
(10) Pub. No.: US 2022/0270869 A1
(43) Pub. Date: Aug. 25, 2022

(54) MASS SPECTROMETER

(71) Applicant: SHIMADZU CORPORATION, Kyoto-shi (JP)

(72) Inventor: Junichi TANIGUCHI, Kyoto-shi (JP)

(73) Assignee: SHIMADZU CORPORATION, Kyoto-shi (JP)

(21) Appl. No.: 17/182,330

(22) Filed: Feb. 23, 2021

(51) Int. Cl. H01J 49/36; H01J 49/42

(52) U.S. Cl. CPC H01J 49/36; H01J 49/4225

(57) ABSTRACT

A mass spectrometer includes: a multi-pole ion guide including a first electrode pair and a second electrode pair arranged symmetrically with respect to the central axis; a first transmission portion connected to the first electrode pair and transmits an RF voltage to be applied to the first electrode pair; and a second transmission portion connected to the second electrode pair and transmits an RF voltage to be applied to the second electrode pair, wherein: the first transmission portion includes a capacitor that reduces the difference between the capacitance of the first transmission portion and the capacitance of the second transmission portion.

### INCORPORATION BY REFERENCE

The disclosure of the following application is herein incorporated by reference: Japanese Patent Application No. 2018-163766 filed Aug. 31, 2018.

### TECHNICAL FIELD

The present invention relates to a mass spectrometer.

### BACKGROUND ART

A mass spectrometer provided with a multi-pole rod electrode (multi-pole ion guide) in which a plurality of rod electrodes is arranged around a central axis is widely used. For example, a linear ion trap using a quadrupole rod is provided with four rod electrodes which are with a X rod electrode pair arranged in the ±X direction and a Y rod electrode pair arranged in the ±Y direction from the central axis. In order to trap the ions, RF voltages with different phases of 180 degrees are applied to the X rod electrode pair and the Y rod electrode pair.

In the linear ion trap, not only a trap of ions but also an isolation in which only ions of m/z (mass-to-charge ratio) in a specific range are left in the ion trap and ions of other m/z are excluded from the ion trap are performed. In addition, a fragmentation is also performed in which kinetic energy is applied only to ions in a specific range of m/z to collide with other molecules.

In order to perform the isolation or the fragment of ions having m/z ions in a specific range, an AC voltage for ion excitation is further applied to either the X rod electrode pair or the Y rod electrode pair.

As described above, in order to perform the linear ion trap, a constitution in which two types of voltages are superimposed on an electrode is necessary. The power source for such purpose is disclosed, for example, in FIG. 2 of Non-Patent Literature 1 (NPL 1). In the linear ion trap disclosed in NPL 1, RF voltage for the trap is applied directly to the X rod electrode pair from an RF power supply (MAIN RF DRIVE). On the other hand, RF voltage for performing trap is applied to the Y rod electrode pair from the RF power supply via the secondary side of a transformer which superimposes AC voltage.

To the primary side of the transformer, an AUX DRIVE is connected and AC voltage generated by the AUX DRIVE is superimposed on the RF voltage for trap, by the transformer and input to the Y rod electrode pair.

### CITATION LIST

### Non-Patent Literature

NPTL 1: J.M. Campbell et al. “A New Linear Ion Trap Time-of-flight System with Tandem Mass Spectrometry Capabilities”, Rapid Commun. Mass Spectrom., Vol. 12, pp. 1463-1474 (1998)

### SUMMARY OF INVENTION

### Technical Problem

In the linear ion trap disclosed in NPL 1, RF voltage and AC voltage are superposed using a transformer. Since the transformer has a capacitance, the capacitance between the Y-rod electrode pair to which RF voltage is supplied through the transformer and the ground is larger than the capacitance between the X-rod electrode pair to which the RF voltage is directly supplied from the RF power supply and the ground. This difference in capacitance causes a difference in the potential (absolute value of the potential) between the X-rod electrode pair and the Y-rod electrode pair at the time when AC voltage is applied.

In a case where the absolute values of the potentials applied to the X-rod electrode pair and the Y-rod electrode pair are equal, no electric field is generated on the central axis of the linear ion trap. However, in a case where the above capacitances are different, the potentials (absolute values of potentials) between the X-rod electrode pair and the Y-rod electrode pair become to be different, and then AC electric field changing according to the change of the AC voltage is generated on the central axis. This AC electric field forms a so-called pseudo-potential that is proportional to the square of the electric field.

Since this pseudo-potential acts as a barrier against ions going to enter the linear ion trap from the outside, it becomes harder for the ions to be introduced into the linear ion trap, which causes a decrease in the detection sensitivity of the mass spectrometer.

### Solution to Problem

A mass spectrometer according to the 1st aspect comprises: a multi-pole ion guide including a first electrode pair and a second electrode pair arranged symmetrically with respect to the central axis; a first transmission portion connected to the first electrode pair and transmits an RF voltage to be applied to the first electrode pair; and a second transmission portion connected to the second electrode pair and transmits an RF voltage to be applied to the second electrode pair, wherein: the first transmission portion includes a capacitor that reduces the difference between the capacitance of the first transmission portion and the capacitance of the second transmission portion.

### Advantageous Effects of Invention

According to the present invention, the efficiency of ion incidence on a linear ion trap (multi-pole ion guide) is increased, which improves the detection sensitivity of the mass spectrometer.

### BRIEF DESCRIPTION OF DRAWINGS

FIG. 1A is a diagram showing a mass spectrometer according to the first embodiment.

FIG. 1B is a diagram showing details of a rod electrode and a power supply for supplying a voltage to the rod electrode.

FIG. 2 is a diagram showing a variation of a power supply circuit that supplies a voltage to the rod electrode.

FIG. 3 is a diagram showing a mass spectrometer according to the second embodiment.

### DESCRIPTION OF EMBODIMENTS

Mass spectrometer according to First Embodiment

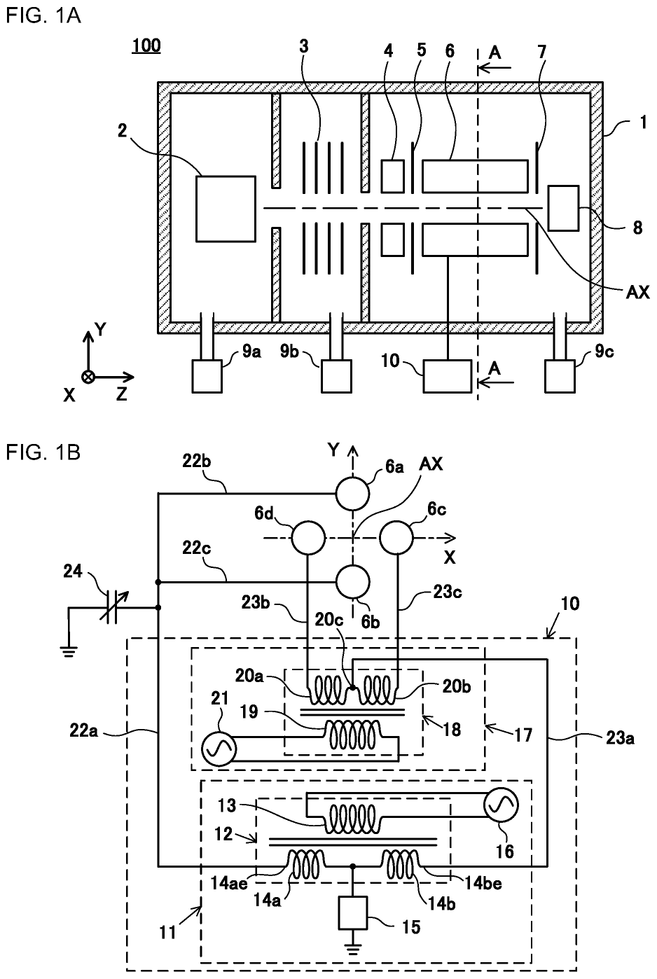

FIG. 1A is a diagram showing a mass spectrometer 100 according to the first embodiment of the present invention, and FIG. 1B is a diagram showing details of a multi-pole rod electrode 6 and a power supply 10 that supplies a voltage to the multi-pole rod electrode 6. In the mass spectrometer 100, an ionization chamber 2, an ion optical system 3, an ion optical system 4, the multi-pole rod electrode (multi-pole ion guide) 6, and an ion detector 8 are provided inside a vacuum container 1 along the central axis AX. The inside of the vacuum container 1 substantially sealed is evacuated by vacuum pumps 9a, 9b, and 9c.

It is to be noted that the direction of the Z axis shown in FIG. lA coincides with the direction of the central axis AX of the multi-pole rod electrode 6.

The ionization chamber 2 is a device for ionizing a gaseous sample or a liquid sample supplied from the outside. The ionization chamber 2 ionizes the sample by, for example, electron ionization, chemical ionization, atmospheric pressure chemical ionization, and electrospray ionization.

Ions generated in the ionization chamber 2 are drawn out from the ionization chamber 2 and introduced into the ion optical system 4 through the ion optical system. The ion optical system 4 is provided with, for example, four rod electrodes, so as to surround the central axis AX, at positions separated by predetermined distances from the central axis AX in the ±X direction and the ±Y direction in FIG. 1B. To the ion optical system 4, high frequency voltage is applied from a power supply circuit (not shown).

The ions that have passed through the ion optical system 4 pass through the entrance side end electrode 5 in which the ion transmission hole is formed in the vicinity of the central axis AX, and are introduced into the multi-pole rod electrode (multi-pole ion guide) 6. Similar to the ion optical system 4, the multi-pole rod electrode 6 is also provided with, for example, four rod electrodes 6a to 6d, so as to surround the central axis AX, at positions separated by predetermined distances from the central axis AX in the ±X direction and the ±Y direction in FIG. 1B.

Hereinafter, in the first embodiment, the multi-pole rod electrode (multi-pole ion guide) 6 will be described as a linear ion trap 6, for example.

In the vicinity of the exit side (right side in the figure) of the linear ion trap 6, an exit side end electrode 7 having an ion transmission hole formed in the vicinity of the central axis AX is provided. To the entrance side end electrode 5 and the exit side end electrode 7 respectively, predetermined voltages are applied from a power supply (not shown). Further, predetermined voltages are applied from the power supply circuit 10 to the rod electrodes 6a to 6d constituting the linear ion trap 6.

By setting the potentials of the rod electrodes 6a to 6d lower than the potentials of the entrance side end electrode 5 and the exit side end electrode 7 and applying predetermined RF voltages to the rod electrodes 6a to 6d, the ions having entered into the linear ion trap 6 can be confined in the linear ion trap 6. Further, by lowering the potential of the exit side end electrode 7 to be lower than the potential of the rod electrodes 6a to 6d at a predetermined time, the ions confined in the linear ion trap 6 can be transferred to the ion detector 8 through the ion transmission hole of the exit side end electrode 7.

FIG. 1B is a diagram showing details of the power supply circuit 10 that supplies a voltage to the four rod electrodes 6a to 6d constituting the linear ion trap 6. In the following, among of the four rod electrodes 6a to 6d, with respect to the central axis AX, a pair of the rod electrode 6c arranged on the +X side and the rod electrode 6d arranged on the −X side is referred to as an X rod electrode pair (6c, 6d). Further, with respect to the central axis AX, a pair of the rod electrode 6a arranged on the +Y side and the rod electrode 6b arranged on the −Y side is referred to as a Y rod electrode pair (6a, 6b).

In the present specification, the RF voltage means an AC voltage having a frequency f of about 0.3 to 10 MHz.

Generally, in the linear ion trap 6, the RF voltages having the same absolute values and reverse signs are respectively applied to the X rod electrode pair (6c, 6d) and the Y rod electrode pair (6a, 6b). Supposing the maximum value of the RF voltage is Q, the RF voltage can be expressed as Q cosωt. Here, ω is an angular frequency (w=27d).

As one example, supposing that RF voltage of Q cosωt is applied to the X rod electrode pair (6c, 6d), and RF voltage of −Q cosωt is applied to the Y rod electrode pair (6a, 6b). In such a case, ions of m/z (mass-to-charge ratio) in a predetermined range can be confined in the linear ion trap 6 without being dispersed in the X direction and Y direction.

Further, in order to perform isolation or fragmentation of ions in a specific range of m/z, one of to the X rod electrode pair (6c, 6d) or the Y rod electrode pair (6a, 6b), the AC voltage for ion excitation is applied in superimposing to the above RF voltage. The frequency of the AC voltage for ion excitation is, as one example, is equal or less than half the frequency of the RF voltage described above.

The power supply circuit 10 is configured to apply the above-mentioned voltage to the four rod electrodes 6a to 6d.

An RF power supply circuit 11 has a resonance circuit transformer 12, and an AC voltage having a predetermined frequency f is input from an RF power supply 16 to a primary coil 13 of the resonance circuit transformer 12. The resonance circuit transformer 12 is provided with a secondary coil 14a and a secondary coil 14b side by side. The RF voltage is generated with amplifying the voltage of input frequency f from the RF power supply 16 by an LC resonance circuit formed by the inductances of the secondary coils 14a and 14b and the capacitances connected to high voltage ends 14ae and 14be of the secondary coil. Here, the above-mentioned capacitances mean those of the capacitances of the X rod electrode pair (6c, 6d) and the Y rod electrode pair (6a, 6b), various capacitances appearing in lead wires 22a to 22c, 23a to 23c, capacitor 24, and the capacitance of an isolation transformer 18.

Thereby, at the high voltage ends 14ae and 14be of the secondary coil, RF voltages having a phase difference of 180 degrees to each other are generated. The RF voltage generated at the high voltage end 14be is applied to the X rod electrode pair (6c, 6d), while the RF voltage generated at the high voltage end 14ae is applied to the Y rod electrode pair (6a, 6b).

Further, to one end of the secondary coil 14a and one end of the secondary coil 14b, a DC voltage P is applied from a DC power supply 15 with reference to the ground; and to the X rod electrode pair (6c, 6d) and the Y rod electrode pair (6a, 6b), the DC voltage P is supplied in superimposing to the above RF voltage described above. In the following embodiments, the case where the DC voltage P is 0 V (GND potential) will be described for ease of understanding.

The high voltage side end 14be of the secondary side coil 14b is connected, via the lead wire 23a, to an intermediate point 20c between a secondary side coil 20a and a secondary side coil 20b of the isolation transformer 18 constituting a voltage superimposition circuit 17. To a primary side coil 19 of the isolation transformer 18, an AC voltage having a frequency of half or less of the RF voltage, an angular frequency p, and a voltage fluctuates around the ground potential is applied from a AC power supply 21. Thereby, to the Y rod electrode pair (6a, 6b), only the RF voltage generated at the high voltage end 14ae is applied. On the other hand, to the rod electrode 6d and the rod electrode 6c constituting the X rod electrode pair (6c, 6d), each one of a pair of AC voltages having a phase difference of 180 degrees with each other superimposed on the RF voltage generated at the high voltage end 14be is applied.

Here, the path between the high voltage end 14be of the secondary coil 14b and the X rod electrode pair (6c, 6d), that is, the path including the lead wire 23a, the voltage superimposition circuit 17, and the lead wires 23b, 23c is referred to as an X side transmission portion. Further, the path between the high voltage end 14ae of the secondary coil 14a and the Y rod electrode pair (6a, 6b), that is, the lead wires 22a to 22c is referred to as a Y side transmission portion. If the capacitor 24 is not connected to the lead wire 22, since the capacitance derived from the isolation transformer 18 exists in the X side transmission portion, the capacitance of the X side transmission portion is larger than the capacitance of the Y side transmission portion.

Therefore, in the mass spectrometer 100 according to the first embodiment, the capacitor 24 that forms a capacitance with the ground is added to at least one portion in the Y side transmission portion (the lead wires 22a to 22c) connecting the high-voltage end 14ae of the secondary coil 14a and the Y-rod electrode pair (6a, 6b). By providing the capacitor 24, the difference between the capacitance between the Y side transmission portion (the lead wires 22a to 22c) and the ground and the capacitance between the X side transmission portion (the voltage superimposition circuit 17, the lead wires 23a to 23c) and the ground is reduced.

Thereby, the magnitude of the AC electric field generated on the central axis AX upon applying the RF voltage can be reduced. That is, since the value of the pseudo-potential can be reduced, the efficiency of introducing ions into the linear ion trap 6 can be improved.

If the capacitance Cy of the Y rod electrode pair (6a, 6b) and the Y side transmission portion (the lead wires 22a to 22c) is different from the capacitance Cx of the X rod electrode pair (6c, 6d) and the X side transmission portion (the voltage superimposition circuit 17, the lead wires 23a to 23c), a problem will occur. This problem will be described here. As described above, RF voltages having a phase difference of 180 degrees are generated at the high voltage ends 14ae and 14be of the secondary coil. Supposing the potential difference between the two RF voltages to be V.

The X side transmission portion and the Y side transmission portion are arranged in series interposing the X-rod electrode pair (6c, 6d) and the Y-rod electrode pair (6a, 6b). Therefore, the sum of the impedances of both acts as a load of the RF power supply circuit 11. That is, from the RF power supply circuit 11, the current I determined by the expression (1) flows.

V·I·(1/jωCx+1/jωCy) (1)

Here, j is an imaginary unit, 1/jωCx is the impedance due to the capacitance Cx, and 1/jωCy is the impedance due to the capacitance Cy.

The potential difference Vx applied to the X rod electrode pair (6c, 6d) and the X side transmission portion (the voltage superimposition circuit 17, the lead wires 23a to 23c), having the capacitance Cx, is expressed by the expression (2).

Vx=I·(1/jωCx)=V·Cy/(Cx+Cy) (2)

On the other hand, the potential difference Vy applied to the Y rod electrode pair (6a, 6b) and the Y side transmission portion (the lead wires 22a to 22c), having the capacitance Cy, is expressed by the equation (3).

Vy=I·(1/jωCy)=V·Cx/(Cx+Cy) (3)

Therefore, in the case where the capacitance Cx and the capacitance Cy are different, the potential difference Vx and the potential difference Vy do not become to be equal to each other. In such a case, even if the RF power supply circuit 11 generates a symmetrical potential such as −1/2 V to the output unit 14ae and 1/2 V to the output unit 14be, the potential applied to the X rod electrode pair (6c, 6d) and the potential applied to the Y rod electrode pair (6a, 6b) will not be symmetrical. Moreover, since the potential difference V is an RF voltage as described above, the potential difference Vx and the potential difference Vy are also RF voltages, that is, they vibrate at a high frequency with time.

As a result, an electric field that vibrates at a high frequency in accordance with the vibration of the potential difference Vx and the potential difference Vy is generated on the central axis AX located at the center of the rod electrodes 6a to 6d. This high-frequency electric field forms a pseudo-potential proportional to the square of the electric field, and forms a barrier against ions going to enter the linear ion trap 6 from the outside.

In the first embodiment, as described above, the capacitor 24 is added to at least one portion of the Y side transmission portion (the lead wires 22a to 22c). Thereby, the difference, between the capacitance Cy which is of the Y rod electrode pair (6a, 6b) and the Y side transmission portion (the lead wires 22a to 22c), and the capacitance Cx which is of the X rod electrode pair (6c, 6d) and the X side transmission portion (the voltage superimposition circuit 17, the lead wires 23a to 23c), is reduced. As a result, magnitude of the AC electric field formed on the central axis AX can be reduced, and the efficiency of introducing ions into the linear ion trap (multi pole ion guide) 6 can be improved.

As the capacitor 24 to be added to the Y side transmission portion (the lead wires 22a to 22c), for example, a capacitor having excellent withstand voltage resistance and high frequency characteristics such as a ceramic capacitor can be used. As shown in FIG. 1B, a variable capacitor having a variable capacitance may also be used. In such a case, even if the capacitance of the transmission portion (the lead wires 22a to 2c, the voltage superimposition circuit 17, and the lead wires 23a to 23c) changes due to changes in temperature, humidity or change over time, there is an advantage that the capacitance can be adjusted by compensating for the change.

The capacitor 24 is not limited to a capacitor as a so-called electronic component. For example, it may be configured that a plate-shaped electrode is attached to a part of the Y-side transmission portion (lead wires 22a to 22c) so as to face the outer wall or inner wall of the ion 1 maintained at the ground potential to generate a capacitance.

### Variation of Power Supply Circuit

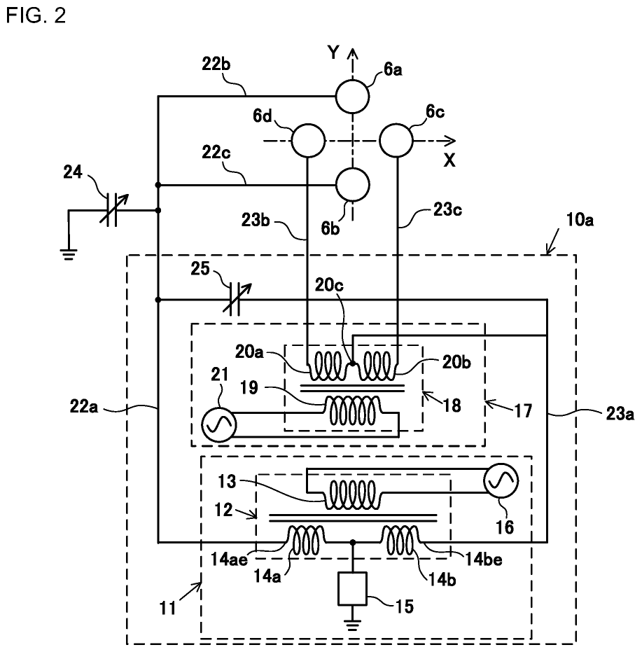

FIG. 2 is a diagram showing a power supply circuit 10a as a variation supplying an RF voltage to the multi-pole rod electrode 6. Since the configuration of the power supply circuit 10a of the variation is almost the same as the configuration of the power supply circuit 10 in the above-described first embodiment, the same portions are designated by the same signs and the description thereof will be omitted.

In the power supply circuit 10a of the variation, in addition to the power supply circuit 10 described above, a variable capacitor 25 for adjusting the resonance condition of the resonance circuit transformer 12 is provided between the lead wires 22a to 22c constituting the Y side transmission portion and the lead wires 23a to 23c constituting the X side transmission portion.

In the power supply circuit 10a of the present variation, the resonance condition based on the RF power supply circuit 11 and the lead wires 22a to 22c, 23a to 23c, and the like are changed by changing the capacitance of the variable capacitor 25, and thereby the RF power supply circuit 11 can generate RF voltage of predetermined range of frequency f.

In the above first embodiment and the variation, the multi-pole rod electrode 6 is a quadrupole having four rod electrodes. However, the number of the rod electrodes of the multi-pole rod electrodes 6 is not limited to four, and may be eight. In such a case, each the power supply circuit 10, 10a is configured to supply predetermined voltage to such number of the rod electrodes of the multi-pole rod electrode 6.

In the above first embodiment and the variation, one transmission portion supplies voltage from the RF power supply 11 to each two rod electrodes (X rod electrode pair (6c, 6d) or Y rod electrode pair (6a, 6b)), respectively. However, the number of rod electrodes to which one transmission portion supplies voltage is not limited to two, and may be any number. For example, in the case of an octupole rod electrode composed of eight rod electrodes, a voltage may be supplied from one transmission portion to four rod electrodes.

In the above first embodiment and the variation, the voltage superimposition circuit 17 is composed of the isolation transformer 18. However, as the voltage superimposition circuit 17, another circuit may be used as long as it is a circuit capable of superimposing an AC voltage on the RF voltage. For example, a circuit using a power semiconductor element can also be used.

In the above first embodiment and the variation, the multi-pole rod electrode (multi-pole ion guide) 6 constitutes a linear ion trap. However, not limited to this, a multi-pole mass filter may be configured. In this case, the entrance side end electrode 5 and the exit side end electrode 7 are not essential and can be appropriately removed.

### Advantageous Effects of First Embodiment and Variation

(1) The mass spectrometer according to the first embodiment and the variation, described above comprises: the multi-pole ion guide (the linear ion guide 6) including the first electrode pair (the Y rod electrode pair 6a, 6b) and the second electrode pair (the X rod electrode pair 6c, 6d) arranged symmetrically with respect to the central axis AX; the first transmission portion (the lead wires 22a-22c) connected to the first electrode pair 6a, 6b and transmits an RF voltage to be applied to the first electrode pair 6a, 6b; and the second transmission portion (the voltage superimposition circuit 17, lead wires 23a-23c) connected to the second electrode pair 6c, 6d and transmits an RF voltage to be applied to the second electrode pair 6c, 6d, wherein: the first transmission portion (the lead wires 22a-22c) includes the capacitor 24 that reduces the difference between the capacitance of the first transmission portion (the lead wires 22a-22c) and the capacitance of the second transmission portion (the voltage superimposition circuit 17, lead wires 23a-23c). With this configuration, in a case where an RF voltage is applied, the magnitude of an AC electric field generated on the central axis AX of the multi-pole ion guide 6 can be reduced, and the value of the pseudo potential can be reduced. As a result, the efficiency of introducing ions into the multi-pole ion guide (the linear ion trap) 6 can be improved, and the detection sensitivity of the mass spectrometer can be improved.
(2) By using the variable capacitor as the capacitor 24, even if the capacitance of the transmission portion (the lead wires 22a to 2c, the voltage superimposition circuit 17, and the lead wires 23a to 23c) changes due to changes in temperature, humidity or change over time, the capacitance can be adjusted as compensating the change thereof.
(3) Another transmission portion (the voltage superimposition circuit 17, lead wires 23a-23c ) includes the voltage superimposition circuit 17 that superimposes an AC voltage on the RF voltage; and the capacitance of the capacitor 24 included in the first transmission portion (the lead wires 22a-22c) is substantially equal to the capacitance of the voltage superimposition circuit 17. With such a configuration, the capacitance added by the voltage superimposition circuit 17 can be easily compensated by the capacitor 24.
(4) By using the isolation transformer 18 as the voltage superimposition circuit 17, it is possible to efficiently superimpose an AC voltage on an RF voltage.
(5) By including the variable capacitor 25 that adjusts the capacitance between the first transmission portion (lead wires 22a to 22c) and the second transmission portion (lead wires 23a to 23c), resonance conditions of the RF power supply circuit 11 and the circuit including the lead wires 22a-22c and 23a-23c can be changed to supply the RF voltage having frequency f in a predetermined range to the multi-pole ion guide 6.
(6) By using the multi-pole ion guide 6 as the electrode constituting the linear ion trap, it is possible to realize the mass spectrometer with improved ion introduction efficiency into the linear ion trap.
(7) By using the multi-pole ion guide 6 as the electrode constituting the multi-pole mass filter, it is possible to realize the mass spectrometer with improved ion introduction efficiency into the quadrupole mass filter.
   Mass spectrometer according to Second Embodiment

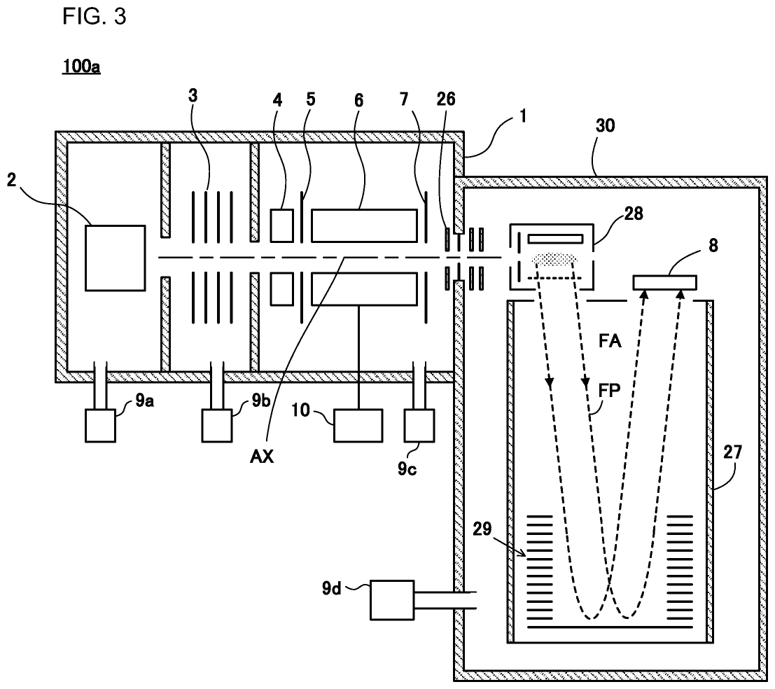

FIG. 3 is a diagram showing a configuration of a mass spectrometer 100a according to the second embodiment of the present invention. Since most of the configurations of the mass spectrometer 100a according to the second embodiment are common to the configurations of the mass spectrometer 100 according to the first embodiment described above, the same portions are designated by the same signs and the description thereof will be omitted.

The mass spectrometer 100a according to the second embodiment has a configuration in which another mass spectrometry unit 30 is provided after the multi-pole rod electrode 6 of the mass spectrometer 100 according to the first embodiment described above. Specifically, the mass spectrometry unit 30 is a time-of-flight mass spectrometry unit 30 having a flight tube 27 and an orthogonal acceleration electrode 28, and ions ejected from the multi-pole rod electrode 6 are guided by the ion optical system 26 and enter the orthogonal acceleration electrode 28. Then, the ions are accelerated by the orthogonal acceleration electrode 28 and flies along the flight path FP in the flight space FA in the flight tube 27. The ions flying in the flight space FA are reflected by a reflector 29 and detected by the ion detector 8.

Since velocity of ion flying in the flight path FP correlates with the m/z of the ion, the amount corresponding to m/z of the ion can be measured by measuring the flight time of the ion. Thereby, the time-of-flight mass spectrometry unit 30 can perform mass spectrometry.

Also in the second embodiment, by using the multi-pole ion guide (multi-pole rod electrode) 6 as the linear ion trap 6 and analyzing a large number of ions accumulated in the linear ion trap 6 by the time-of-flight mass spectrometry unit 30, mass spectrometry can be performed with good S/N. Further, the ions fragmented in the linear ion trap 6 can also be analyzed by the time-of-flight mass spectrometry unit 30.

Alternatively, it is possible that a multi-pole ion guide (multi-pole rod electrode) 6 is used as a multi-pole mass filter and a collision cell (not shown) is arranged between the multi-pole mass filter and the time-of-flight mass spectrometry unit 30. In such a case, the precursor ions selected by the multi-pole mass filter composing of the multi-pole rod electrode 6 are cleaved in the collision cell, and mass spectrometry of various product ions generated by the cleaving can be performed accurately by the time-of-flight mass spectrometry unit 30. It is to be noted that, the mass spectrometry unit 30 is not limited to the time-of-flight mass spectrometry unit 30 described above, and may be other type quadrupole mass spectrometry unit.

### Advantageous Effects of Second Embodiment

(8) The mass spectrometer according to the second embodiment further includes, in addition to the mass spectrometer according to the first embodiment and the variation described above, another mass spectrometry unit provided after the multi-pole ion guide (multi-pole rod electrode) 6.

With such a configuration, the entrance efficiency of the ions to the ion trap portion (multipolar ion guide 6) of the ion trap type time-of-flight mass spectrometer can be increased, and the detection sensitivity of the mass spectrometer can be improved. Alternatively, the entrance efficiency of the ions to the multi-pole mass filter (multi-pole ion guide 6) in the former stage of the so-called tandem mass spectrometer can be increased, and the detection sensitivity of the mass spectrometer is improved.

Although various embodiments and variations have been described above, the present invention is not limited to these contents. Moreover, each embodiment may be applied individually or may be used in combination. Other aspects that are conceivable within the scope of the technical idea of the present invention are also included within the scope of the present invention.

### REFERENCE SIGNS LIST

100, 100a . . . Mass spectrometer, 1 . . . Vacuum container, 2 . . . Ionization Chamber, 3, 4, 26 . . . Ion Optical System, 6 . . . Linear Ion Trap (multi-pole ion guide), 6a-6d . . . Rod Electrode, 5 . . . Entrance Side End Electrode, 7 . . . Exit Side End Electrode, 8 . . . Ion Detector, 9a-9d . . . Vacuum Pump, 10 . . . Power Supply Circuit, 11 . . . RF Power Supply Circuit, 12 . . . Resonance Circuit Transformer, 15 . . . DC Power Supply, 16 . . . RF Power Supply, 17 . . . Voltage Superimposition Circuit (X Side Transmission portion), 18 . . . Isolation Transformer, 21 . . . AC power supply, 22a-22c . . . Lead Wire (Y Side Transmission portion), 23a-23c . . . Lead Wire (X Side Transmission portion), 24 . . . Capacitor, 25 . . . Variable Capacitor, 27 . . . Flight Tube, 28 . . . Orthogonal Acceleration Electrode, 29 . . . Reflector, 30 . . . Time-of-flight Mass Spectrometry Unit (Another Mass Spectrometry Unit), FA . . . Flight Space, FP . . . Flight Path

1. A mass spectrometer, comprising:
a multi-pole ion guide including a first electrode pair and a second electrode pair arranged symmetrically with respect to a central axis;
a first transmission portion that is connected to the first electrode pair and transmits an RF voltage to be applied to the first electrode pair; and
a second transmission portion that is connected to the second electrode pair and transmits an RF voltage to be applied to the second electrode pair, wherein:
the second transmission portion includes a voltage superimposition circuit that superimposes an AC voltage on the RF voltage; and
the first transmission portion includes a capacitor that reduces a difference between a capacitance of the first transmission portion and a capacitance of the second transmission portion.

2. The mass spectrometer according to claim 1, wherein:
the capacitor is a variable capacitor.

3. The mass spectrometer according to claim 1, wherein:
a capacitance of the capacitor included in the first transmission portion is substantially equal to a capacitance of the voltage superimposition circuit.

4. The mass spectrometer according to claim 3, wherein:
the voltage superimposition circuit is an isolation transformer.

5. The mass spectrometer according to claim 1, further comprising:
a variable capacitor that adjusts a capacitance between the first transmission portion and the second transmission portion.

6. The mass spectrometer according to claim 1, wherein:
the multi-pole ion guide constitutes a linear ion trap.

7. The mass spectrometer according to claim 1, wherein:
the multi-pole ion guide constitutes a multi-pole mass filter.

8. The mass spectrometer according to claim 1, further comprising:
a mass spectrometry unit provided after the multi-pole ion guide.
